(19) United States
(12) Patent Application Publication
(10) Pub. No.: US 2017/0258567 A1
(43) Pub. Date: Sep. 14, 2017

(54) Prophy Paste Container and Supports Therefor

(71) Applicant: E. Robert Wardius, JR., Reading, PA (US)

(72) Inventor: E. Robert Wardius, JR., Reading, PA (US)

(21) Appl. No.: 15/446,270

(22) Filed: Mar. 1, 2017

Related U.S. Application Data
(60) Provisional application No. 62/305,832, filed on Mar. 9, 2016.
(60) Provisional application No. 62/318,856, filed on Apr. 6, 2016.

(51) Int. Cl. A61C 19/00; A61C 17/22; A61C 17/00

(52) U.S. Cl. CPC A61C 19/006; A61C 17/005; A61C 17/22

(57) ABSTRACT

An elongated prophy paste container has a length at least twice the width to receive a prophy cup therein and facilitate the loading of prophy paste thereon for use in a prophy operation. The elongated container can be formed with optional detent members at the opposing ends of the container to engage indents in a corresponding support member to retain the container in engagement with the support member during use of the container. The support member can be configured to mount onto a dental instrument or to incorporate a stand that can sit on a flat surface. The configuration of the support member for mounting on a dental instrument can have a dual receiver configuration to engage dental instruments with different diameters. The configuration of the support member incorporating a stand can be formed with an elongated neck to permit positioning thereof between the fingers of the dental hygienist.

### CROSS-REFERENCE TO RELATED APPLICATIONS

This application claims domestic priority on U.S. Provisional Patent Application Ser. No. 62/305,832, filed on Mar. 9, 2016, and on U.S. Provisional Patent Application Ser. No. 62/318,856, filed on Apr. 6, 2016, the contents of both provisional patent applications being incorporated herein by reference.

### FIELD OF THE INVENTION

This invention relates generally to a small container used in dentist offices, typically by dental hygienists, that contains a supply of prophy paste or other paste applications to be applied to a patient's teeth, usually during a cleaning operation, and, more particularly, to an elongated prophy paste container sized slightly larger than a prophy cup to receive the prophy cup within the container in a manner that will facilitate the application of the prophy paste material into the prophy cup for use by the dental hygienist.

### BACKGROUND OF THE INVENTION

Dental practices typically have dental hygienists, or other dental professionals, that provide a periodic service, referred to as a prophy, to clean and polish a patient's teeth. During this prophy service, the hygienists typically polish the patient's teeth with a rotary device commonly referred to as a prophy angle that is mounted on a dental drill to apply rotary power thereto. At the end of the prophy angle is the hollow prophy cup, which is the rubber-like applicator tip used to collect prophy paste for application to the patient's teeth. The prophy paste for such prophy services is packaged into small individual prophy paste containers that are round and have a flange around the top to secure a releasable cover.

These individually packaged round prophy paste containers are sized to provide the appropriate amount of prophy paste needed for a single prophy operation so that a fresh prophy paste container is utilized with each patient. The known prior art, individually sized, prophy paste container is circular in shape and provided with a rim extending around the upper circumference of the prophy paste container to permit attachment of a releasable cover member that can be peeled away to expose the prophy paste within the prophy paste container. The depth of the prophy paste container provides an adequate supply of prophy paste for a single use.

As noted above, the shape of these prior art individual prophy paste containers is circular. The diameter of the circular prophy paste container is several times larger than the diameter of the prophy cup that is dipped into the prophy paste container to extract a small amount of the prophy paste for application to the patient's teeth. Since the prophy cup may have water or saliva present, getting the prophy paste to fill the hollow prophy cup is sometimes problematic and the hygienist will then need to press the foot pedal controlling the rotation of the prophy cup to make the prophy cup spin or rotate in order to engage the prophy paste within the prophy paste container. The spinning of the prophy cup, however, often causes a splattering of saliva and prophy paste outside of the prophy paste container. Simply scooping the prophy paste out of the prophy paste container without spinning the prophy cup is very difficult due to the incompatibility of the prophy angle and the existing circular prophy paste container.

It would be desirable to provide an improved individual application sized prophy paste container that will be shaped to facilitate the application of prophy paste from the individual prophy paste container into the prophy cup of the rotatable prophy angle used to polish a patient's teeth during the prophy operation. It would also be desirable to provide support structures for mounting prophy paste containers on dental instruments, such as a dental mirror or a saliva ejector, or for supporting the prophy paste container on a flat surface, or within the dental professional's hand.

### SUMMARY OF THE INVENTION

It is an object of this invention to overcome the disadvantages of the prior art by providing a prophy paste container having an elongated configuration to facilitate the engagement of the prophy paste therein onto a prophy cup for application to a patient's teeth during a cleaning operation.

It is another object of this invention to provide a support member for holding the prophy paste container at a convenient location for access by the dental professional.

It is a feature of this invention that the prophy paste container is shaped in an elongated configuration having a width dimension that is slightly greater than the diameter of the prophy cup placed therein to engage the prophy paste.

It is another feature of this invention that the length dimension of the prophy paste container is at least twice as long as the width dimension to provide a sufficient volume within the container to hold an adequate supply of prophy paste for a dental cleaning operation.

It is an advantage of this invention that the shape of the prophy paste container facilitates the placement of prophy paste onto the prophy cup for application to a patient's teeth.

It is another advantage of this invention that the dental professional conducting a prophy operation to clean a patient's teeth does not need to spin the prophy cup to urge prophy paste onto the prophy cup.

It is still another advantage of this invention that the use of the elongated prophy paste container reduces waste of the prophy paste.

It is still another feature of this invention that the end walls of the elongate prophy paste container can be formed with detent members projecting outwardly from the end walls.

It is still another object of this invention to provide a support member for the elongated prophy paste container that includes indents in the receptacle for receiving the elongated prophy paste container for engagement with the detent members on the container.

It is yet another advantage of this invention that the engagement between the detent members on the elongated container and the indents in the support member retain the container in engagement with the support member.

It is yet another feature of this invention that the support members are provided with a receiver structure that will permit mounting thereof onto the shaft of a dental instrument.

It is still another feature of this invention that the support member can include a stand that will sit on a flat surface.

It is another feature of this invention that the stand is contoured to have an elongated neck portion that will fit into a dental professional's hand.

It is still another advantage of this invention that the stand can be held by the dental professional to make the supply of prophy paste readily available for conducting the prophy operation.

It is yet another object of this invention to provide a support member that can receive either a conventional round prophy paste container or an elongated prophy paste container.

It is another feature of this invention that the support member is formed with circular side walls that project outwardly from the body of the support member to accommodate the round shape of the conventional prophy paste container.

It is yet another advantage of this invention that the support member can be sterilized and re-used multiple times to sequential prophy operations while the individual prophy paste containers are disposed when depleted.

It is yet another object of this invention to provide an elongated prophy paste container that is inexpensive to manufacture and simple and effective in use.

It is a further object of this invention to provide a support member for receiving an elongated prophy paste container that positions the container at a convenient position for use in a prophy operation, which is durable in construction, inexpensive of manufacture, carefree of maintenance and simple and effective in use.

These and other objects, features and advantages are accomplished according to the instant invention by providing an elongated prophy paste container having a length at least twice the width to receive a prophy cup therein and facilitate the loading of prophy paste onto the prophy cup for use in a prophy operation to clean a patient's teeth. The elongated container may be formed with detent members at the opposing ends of the container to engage indents in a corresponding support member to retain the container in engagement with the support member during use of the container. The support member can be configured to mount onto a dental instrument or to incorporate a stand that can sit on a flat surface. The configuration of the support member for mounting on a dental instrument can have a dual receiver configuration to engage dental instruments with different diameters. The configuration of the support member incorporating a stand can be formed with an elongated neck to permit positioning thereof between the fingers of the dental hygienist.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a top plan view of a prophy paste container incorporating the principles of the instant invention with optional detents being shown on the interior end surfaces of the reservoir for holding a supply of prophy paste, the removable seal member not being shown for purposes of clarity;

FIG. 2 is a side elevational view of the prophy paste container shown in FIG. 1, the removable seal not being shown for purposes of clarity;

FIG. 3 is an end elevational view of the prophy paste container shown in FIG. 1, the optional detent member being shown projecting out of the end wall of the container;

FIG. 4 is a bottom plan view of the prophy paste container shown in FIG. 1;

FIG. 5 is an upper, front, right perspective view of the prophy paste container shown in FIG. 1;

FIG. 6 is an upper, left, rear perspective view of the prophy paste container shown in FIG. 1;

FIG. 7 is a representative end view of the prophy paste container incorporating the principles of the instant invention having the releasable cover removed and a prophy cup dipped into the reservoir cavity of the prophy paste container in which the prophy paste is located;

FIG. 8 is an upper perspective view of a prophy paste container support member for use on a dental instrument, such as a saliva ejector or dental mirror, as depicted in FIGS. 16 and 17 below, the support member having a cavity into which the prophy paste container can be positioned with optional detent receivers formed into the end walls to be engaged by the optional detent members of the prophy paste container;

FIG. 9 is an end elevational view of the support member shown in FIG. 8;

FIG. 10 is a top plan view of the support member shown in FIG. 8;

FIG. 11 is another upper perspective view of the support member shown in FIG. 8;

FIG. 12 a lower perspective view of the support member shown in FIG. 8;

FIG. 13 is an upper perspective view similar to that of FIG. 8, but showing an alternative configuration of the prophy paste container support member for mounting on dental instruments, the reservoir cavity being configured to hold either the prior art round prophy paste container or the prophy paste container incorporating the principles of the instant invention;

FIG. 14 is an upper perspective view of a support member similar to that shown in FIG. 13, but incorporating a dual diameter mounting portion that is operable to mount on two different diameter dental instruments;

FIG. 15 is an upper perspective view of a support member similar to that shown in FIG. 13, but having the circular flanges of the reservoir cavity being deleted so that the curved ends of the sides of the reservoir cavity will retain the prior art circular prophy paste container in position on the support member;

FIG. 16 is a schematic side elevational view of the prophy paste container mounted in a dental instrument support member and placed onto a saliva ejector;

FIG. 17 is a schematic side elevational view of the prophy paste container and support member mounted on a dental mirror;

FIG. 18 is an upper perspective view of another embodiment of a support member for holding a prophy paste container, the alternative support member having a shaped base member that can sit stably on a flat surface or can be held between the fingers of a dental professional;

FIG. 19 is a lower perspective view of the alternative support member shown in FIG. 18;

FIG. 20 is an upper, side perspective view of the alternative support member shown in FIG. 18;

FIG. 21 is a side perspective view of the alternative support member shown in FIG. 18, the shape of the base member allowing support thereof between the fingers of a dental professional being depicted;

FIG. 22 is a top plan view of the alternative support member shown in FIG. 18; and

FIG. 23 is an upper perspective view of still another alternative embodiment of the alternative support member similar to that depicted in FIG. 18, but with the reservoir cavity shaped as depicted in the support member shown in FIG. 13 to selectively retain either a prior art round prophy paste container or a rectangular prophy paste container incorporating the principles of the instant invention.

### DETAILED DESCRIPTION OF THE PREFERRED EMBODIMENTS

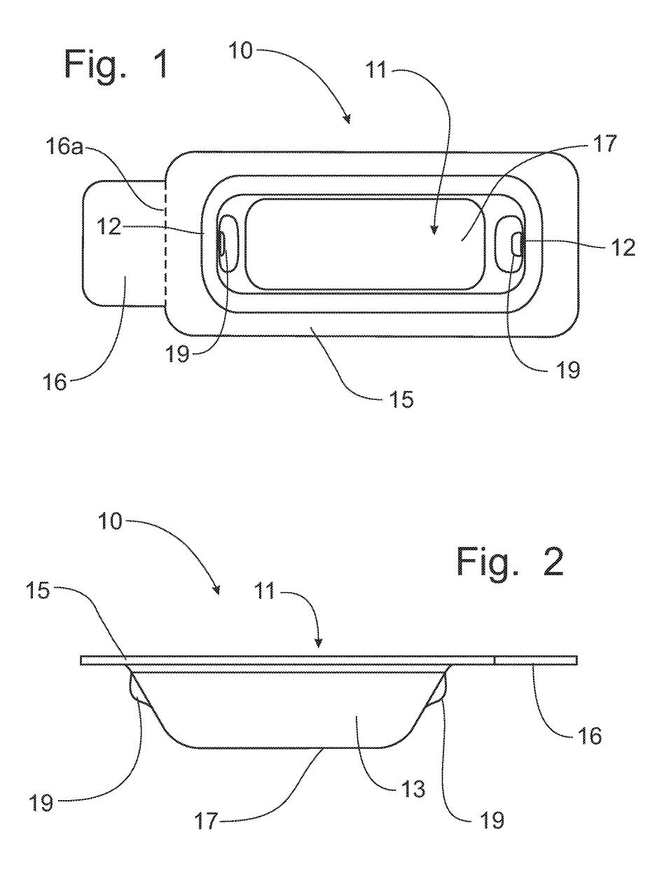

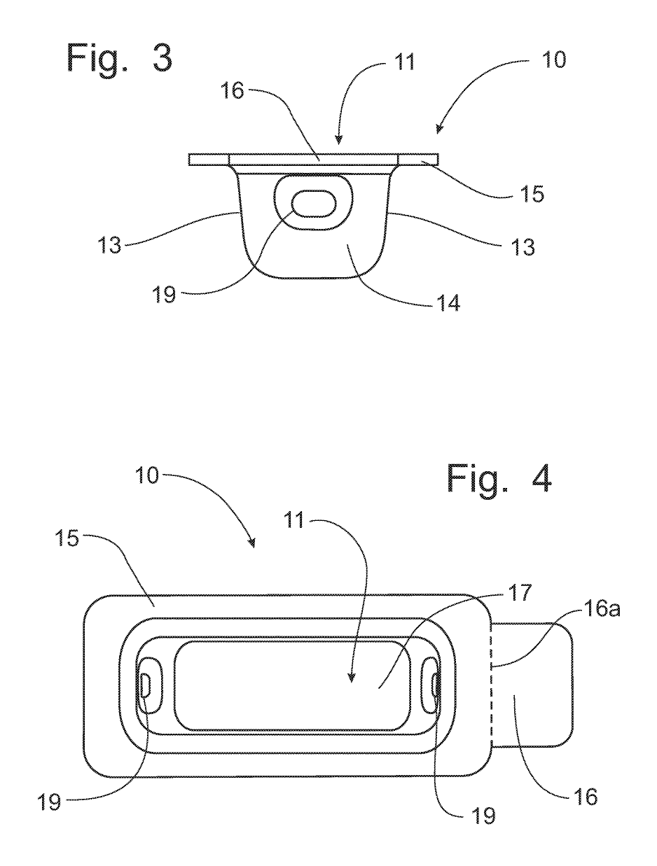

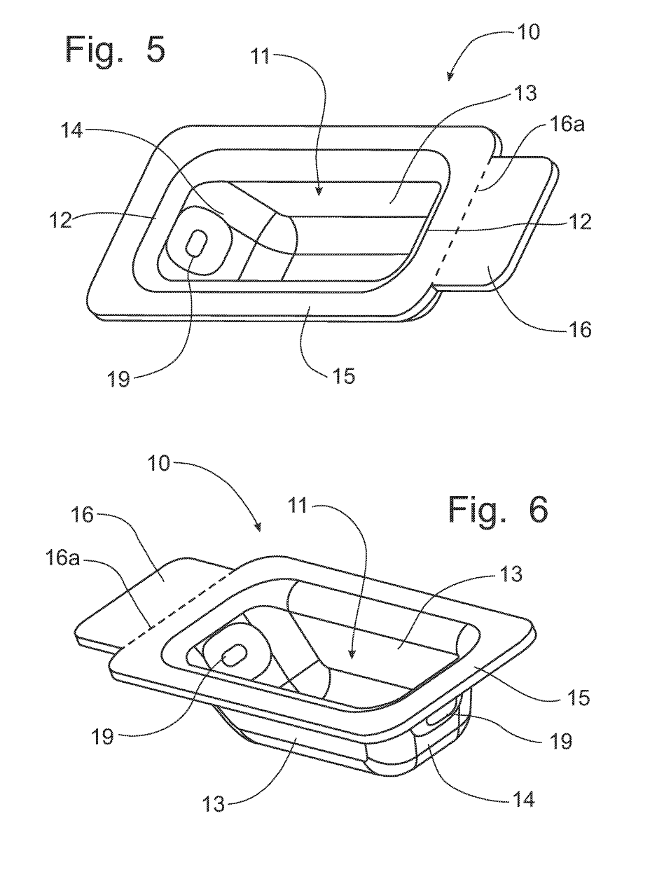

Referring now to FIGS. 1-7, an individually sized rectangular prophy paste container, for utilization at a dental office by a dental professional applying prophy paste to a patient's teeth during a prophy operation for the patient, incorporating the principles of the instant invention can best be seen. The individually sized rectangular prophy paste container 10 can be compared to the conventional prior art individually sized round prophy paste container. Instead of being circular in shape, the individually sized rectangular prophy paste container 10 has a reservoir cavity 11 that is preferably formed with rounded ends 12 and linear sides 13. The depth of the prophy paste container reservoir cavity 11 can provide the same volume for retaining prophy paste as the conventional round containers, but is longer and narrower. However, because of the more efficient gathering of the prophy paste from the reservoir cavity 11 into the prophy cup, as will be explained in greater detail below, less prophy paste per individual prophy paste container would likely be necessary in order to provide an adequate supply for the cleaning a patient's teeth by the dental professional.

The prophy paste container 10 includes a flat rim 15 extending around the perimeter of the upper edge of the prophy paste container 10 to provide a surface against which a top cover, or seal member 18 can be secured to the prophy paste container 10 to seal the prophy paste within the reservoir cavity 11. Preferably, the flat rim 15 includes a front tab 16 that provides a surface over which a loose portion of the seal member 18 can be positioned to facilitate the removable of the seal member 18 before use by the dental professional. The end walls 14 are preferably sloped from the bottom surface 17 of the reservoir cavity 11 to the flat rim 15 in a manner that makes the length dimension of the bottom surface 17 smaller than the length of the reservoir cavity 11 along the flat rim 15.

One skilled in the art will recognize that the end walls 14 could be perpendicular to the bottom surface 17. Similarly, the side walls 13 can be perpendicular to the bottom surface 17 or sloped upwardly from the bottom surface 17 to the flat rim 15, as is depicted for the end walls 14 in FIG. 2. One skilled in the art will also recognize that the shape of the flat rim 15 could be rounded along the sides and/or the ends thereof to make the flat rim more oval-shaped than is shown in FIG. 1. Accordingly, the overall shape of the prophy paste container 10 can vary somewhat provided that the length dimension of the reservoir cavity is at least twice as long as the width dimension and that the width dimension is larger than the diameter of the prophy cup that is engaged into the reservoir cavity 11 to remove prophy paste therefrom.

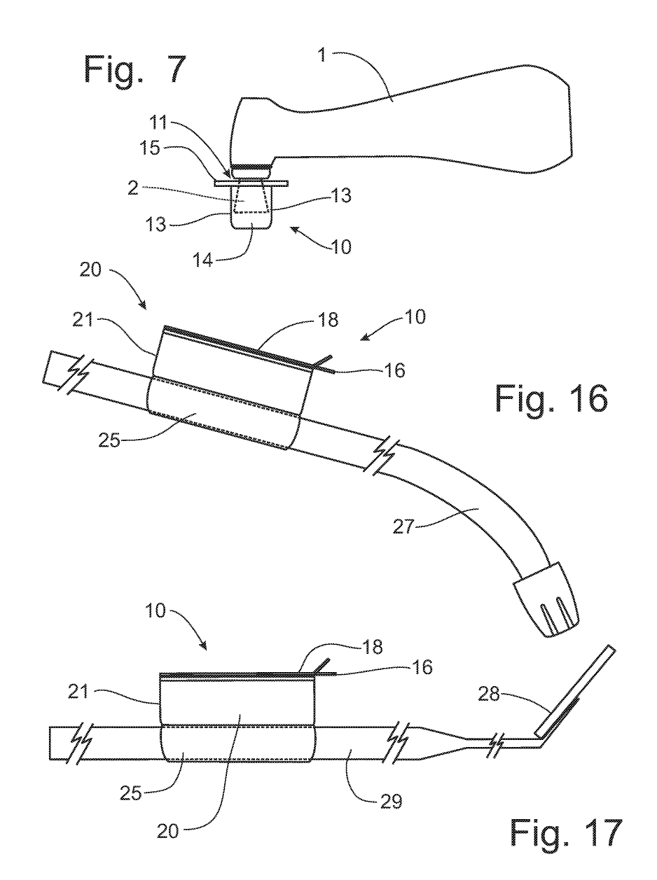

As is depicted in FIG. 7, the dimensions of the prophy paste container 10, specifically the width between the linear sides 13, are designed so that the end of the prophy cup 2 on the prophy angle 1 that a dental hygienist or other dental professional will utilize to apply prophy paste to a patient's teeth, will fit into the reservoir 11 of the container 10. The diameter of the end of a standard prophy cup 2 is approximately 6-7 mm. Accordingly, the width of the bottom of the prophy paste container incorporating the principles of the instant invention should preferably be one cm or less. This rectangular shape of the prophy paste container 10, with the width between the linear sides 13 at the bottom of the container being just slightly larger than a standard prophy cup 2, enables the prophy cup 2 to be pushed toward the rounded ends 14 of the prophy paste container 10 to urge the prophy paste into the prophy cup 2. This scooping action of collecting the prophy paste into the prophy cup 2 is much more efficient than is known in the prior art and eliminates the need to spin the prophy cup 2 to collect the prophy paste, thus preventing the possibility of splattering saliva and prophy paste as often happens with conventional circular prophy paste containers.

The end walls 14 of the container 10 can be formed with an optional detent member 20 that preferably projects outwardly from the reservoir cavity 11 so as not to diminish the volume thereof. As is best seen in FIG. 2, the optional detent members 19 may be formed integrally with the manufacture of the container 10 and provide a structure that can engage a corresponding formation in a support member, as will be described in greater detail below, yet yield under pressure to disengage the corresponding formation. Accordingly, the operation of the detent member 19 is to restrain the prophy paste container 10 while lodged into a support member, yet permit the container 10 to be lifted out of the support member by lifting on the flat rim 15 once the prophy paste within the container 10 has been utilized. Preferably, the extended tab member 16 will be separable from the flat rim 15 by the line of perforation 16a, which will enable the top cover member/seal member 18 to be secured to the extended tab 16 and allow the tab 16 to be broken away from the flat rim 15 to affect removal of the top cover member/seal member 18 from the container 10.

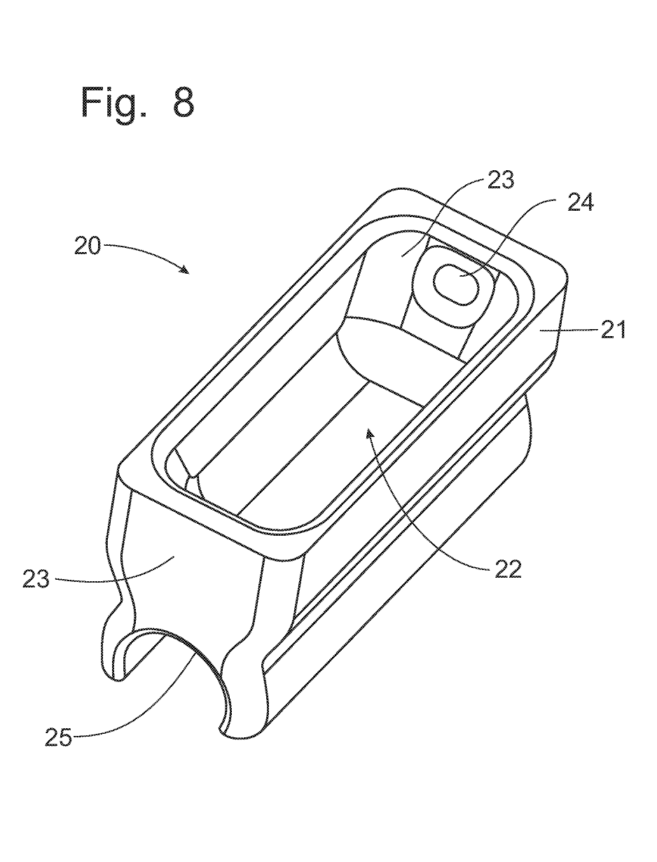

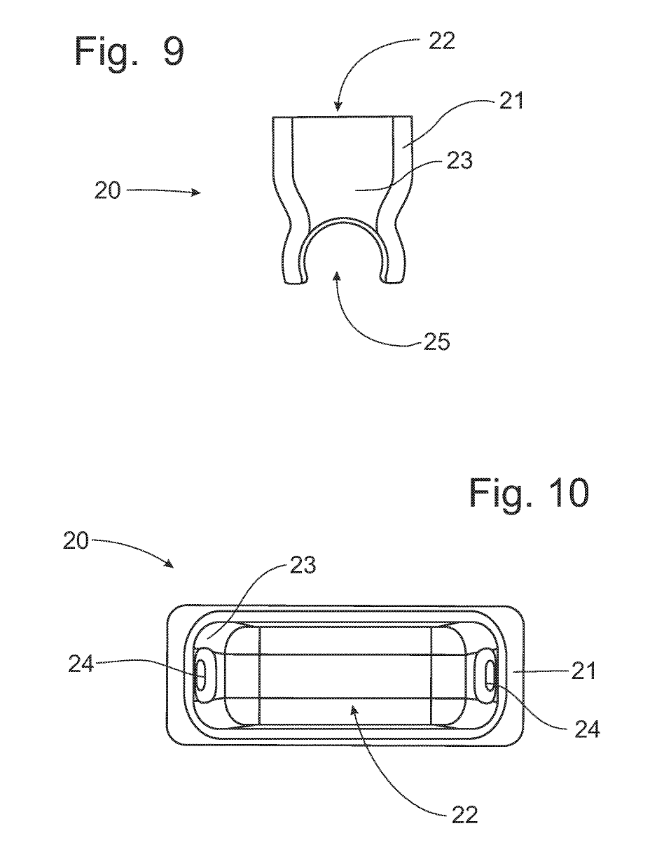

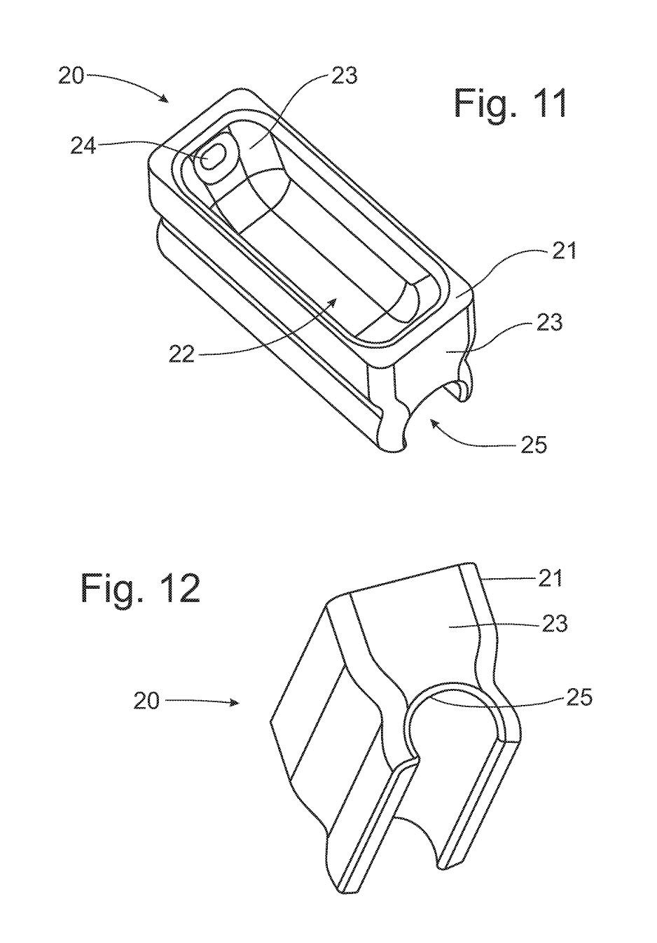

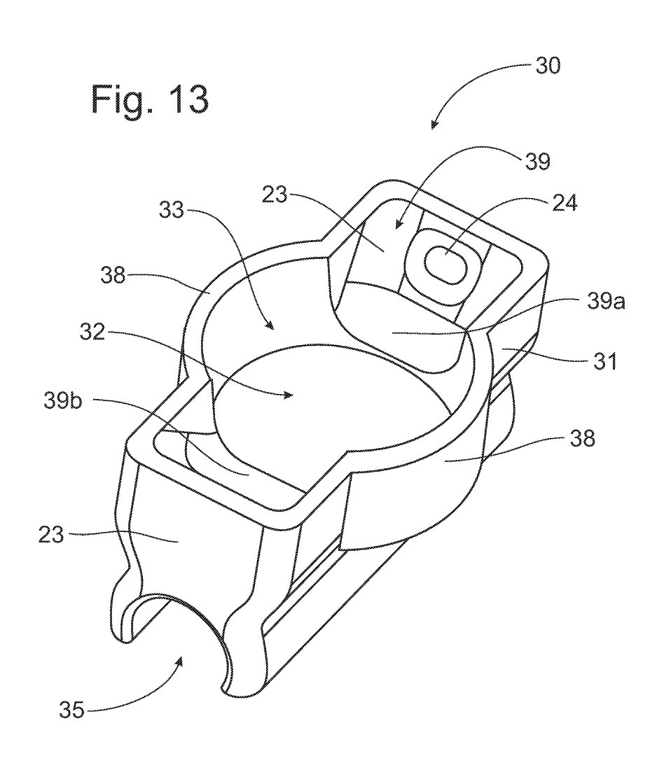

The elongated shape of the improved prophy paste container 10 is particularly adaptable to be mounted on a number of surfaces for convenient access by the dental professional. A first embodiment of a support member 20 can be seen in FIGS. 8-12. This support member 20 is configured for mounting on a dental instrument, such as a saliva ejector or a dental mirror, but preferably a dental instrument that is used extensively during a cleaning operation. The body 21 of the support member 20 is formed in a unitary manner, such as by injection molding plastic, in a manner to define a receptacle 22 configured to receive the prophy paste container 10 as defined above. The lower portion of the body 21 is formed in a semi-circular configuration to define a receiver 25 for the shaft of a dental instrument, as will be described in greater detail below.

One skilled in the art will recognize that other forms of the support member 20 could be effective to hold and retain a prophy paste container 10. As an example, the support member 20 could be formed from metal or plastic with a receiver formed in the lower portion in an appropriate manner to engage the shaft of a dental instrument, and have a U-shaped clip formed in the upper portion that is sized to firmly engage, such as via a spring force, the sides 13 of the container 10. By forming or connecting a receiver 25 on or to the bottom surface of the prophy paste container 10, the support member 20 can be used to mount the prophy paste container 10 on a saliva ejector 27, which can be supported in the patient's mouth to extract liquids while the prophy operation is transpiring, as is depicted in FIG. 16. By appropriate placement of the saliva extractor 27, the prophy paste container 10 can be positioned conveniently for access by the dental hygienist during the prophy operation.

The support member 20 can also be used to mount the prophy paste container 10 on a dental mirror 28, which is frequently utilized by dental hygienists during the prophy operation to view teeth that are not easily seen and to retract cheeks and tongue for better visibility. By appropriate placement of the prophy paste container 10 on the shaft 29 of the dental mirror 28, the supply of prophy paste for the prophy operation would be readily available for access by the dental hygienist during the prophy operation.

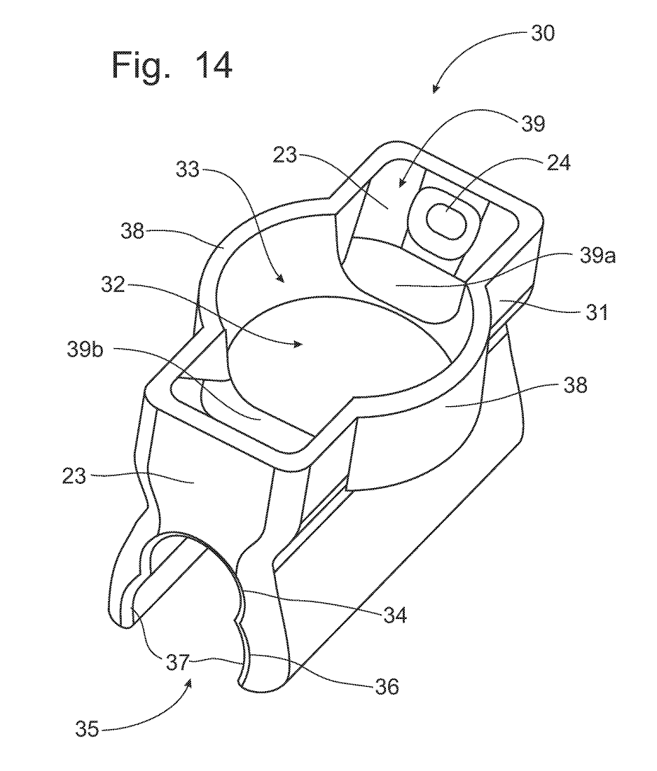

Since the saliva ejector 28 can have substantially the same diameter as the shaft 29 of the dental mirror 28, the receiver 25 will preferably accommodate both dental instruments 27, 28 to provide flexibility in utilization. In situations where the dental instruments would have diameters with sufficient disparity that a single receiver 25 configuration would not be able to accommodate both dental instruments, the receiver can be formed in a dual receiver configuration 35, as is depicted on the lower portion of the support member 30 shown in FIG. 14. Although the configuration of the receptacle 32 of the support member 30 shown in FIG. 14 is different than the receptacle 22 of the support member 20, the dual receiver configuration 35 can be applied to the formation of the support member 20.

In this dual receiver configuration 35, the innermost receiving portion 34 is preferably formed in a generally semi-circular shape to receive and engage a smaller diameter dental instrument, while the outermost receiving portion 36 is shaped as a pair of arcuate segments 37 adjoining the ends of the innermost receiving portion 34 so as to be engagable with a larger diameter dental instrument. When mounted on the larger diameter dental instrument, the opening into the innermost receiving portion 34 is too small to allow entry of the entire larger diameter dental instrument, causing the support member 20, 30 to sit higher on the larger diameter dental instrument than on the smaller diameter dental instrument.

Referring now to FIGS. 8-12, the receptacle 22 of the support member 20 is formed in a shape that will snuggly fit the shape of the prophy paste container 10 such that the flat rim 15 rests on top of the upper surface of the body 21, as is depicted in FIGS. 16 and 17. The end walls 23 of the receptacle 22 can be formed with optional indents 24 that are substantially the same shape as the detent members 19 to enable the optional detent members 19 to fit within the indents 24 once the container 10 is seated within the receptacle 22. In the installation of the container 10 into the support member receptacle 22, the detent member 19 on at least one end thereof would deflect slightly to allow the detent member 19 to pass the top edge of the receptacle 22 and slide into the corresponding indent 24. Once the prophy paste has been depleted, the container 10 can be removed easily by lifting on the flat rim 15 and lifting the container 10 from the receptacle 22, slightly deflecting the indent member 19 in the process.

Another configuration of the support member can be seen in FIGS. 13 and 14. This support member 30 is configured to receive both the conventional, round prophy paste container as well as the improved rectangular prophy paste container 10. The support member 30 has a body 31 that incorporates the receptacle 32 in the upper portion and the receiver 35 in the lower portion. As is described in greater detail above, the receiver 35 can be of a single receiver configuration, as is shown in FIG. 13 and also described above, or of a dual receiver configuration 35, as is depicted in FIG. 14.

However, the receptacle 32 formed into the upper portion of the body 31 incorporates a circular portion 33 that has curved sides 38 projecting outwardly from the body 31. The depth of this circular portion 33 is sufficient to accommodate the placement of a conventional round prophy paste container so that the rim thereof rests on top of the curved sides 38. Retention of the conventional round prophy paste container in the circular portion 33 can be attained through proper sizing of the circular portion 33 and the use of plastic materials that will yield slightly and grip the sides of the conventional round prophy paste container placed therein.

The receptacle 32 can also include a rectangular portion 39 that is sized to receive the improved rectangular prophy paste container 10 described in greater detail above. The rectangular portion 39 essentially comprises the two landings 39a, 39b that are located outside of the circular portion 33 to either side thereof. One skilled in the art will note the difference in depth of the round and rectangular portions 33, 39 within the receptacle 32, which is intended to accommodate the expected height differences between the conventional round prophy paste container and the improved rectangular container 10. Depending on the final dimensions of the rectangular container 10, this depth dimension of the respective circular and rectangular portions 33, 39 might be the same. As with the support member 20, the end walls 23 on the rectangular portion 39 could be formed with optional indents 24 to receive the detent members 19 of the container 10. One of ordinary skill in the art will recognize that the support member 40 could be formed with only the circular portion 33 to receive the conventional round prophy paste containers. However, the flexibility allowed in the receptacle configuration 32 as shown in FIGS. 13 and 14 is desirable.

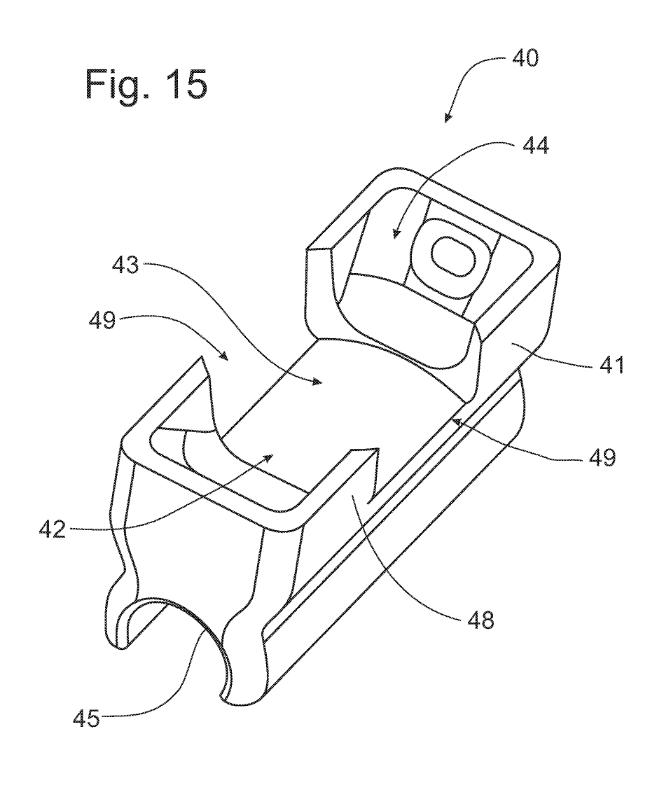

A similarly functional support member 40 is depicted in FIG. 15 to accommodate the placement of either the conventional round prophy paste container or the improved rectangular container 10 described in greater detail above. The support member 40 is formed without the side members 38 that define the circular portion 43 are removed. The conventional round prophy paste containers are accommodated within the receptacle 42 by creating openings 49 in the opposing side walls 48 of the body 41 so that the conventional round prophy paste container can project outwardly from the body 41. The upright ends 41a of the open side walls 48 are curved to mate with the outside of the conventional round prophy paste container and retain the container in the support member 40 when placed therein. The rectangular portion 39 is otherwise identical to the support member 30 described above, including the provision of the indents 24. AS is also described above in greater detail, this support member 40 could also be formed with the dual receiver configuration 35.

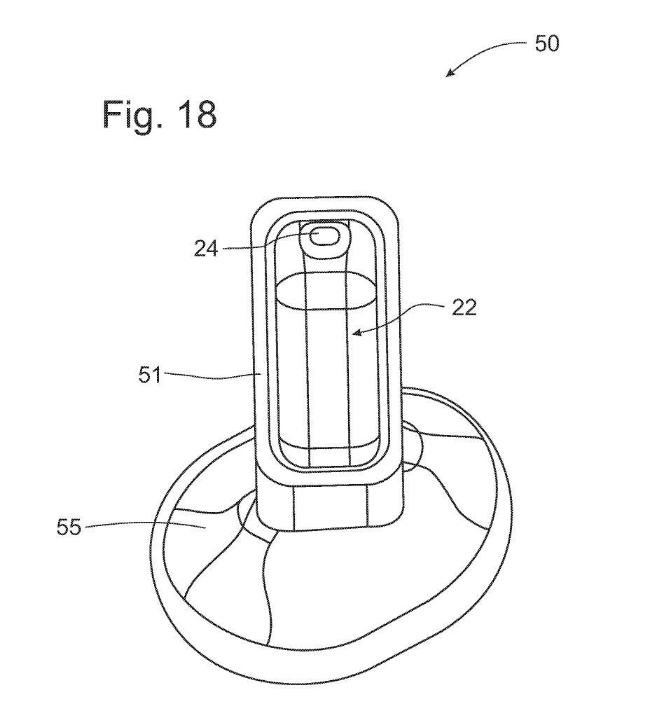

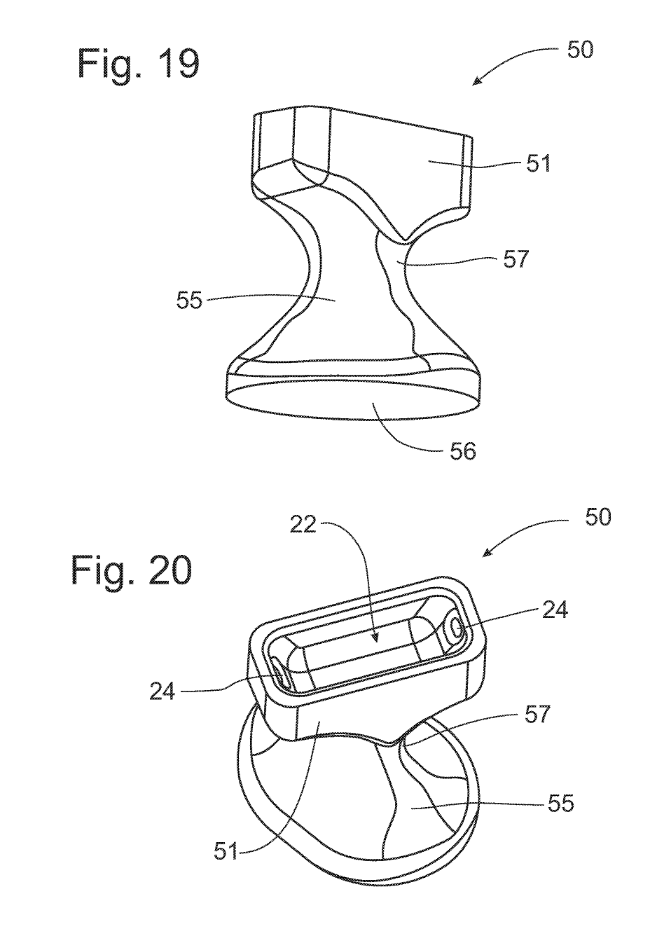

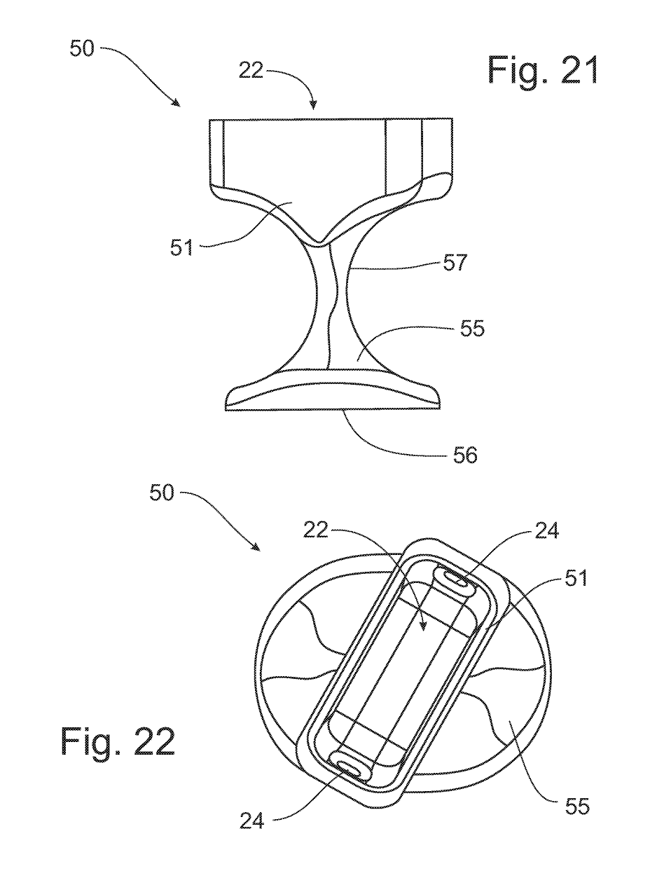

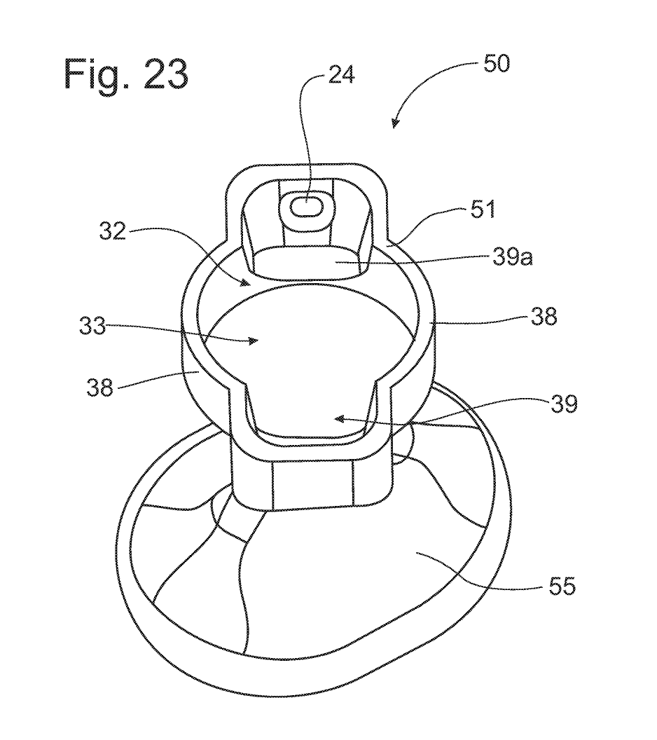

Still another embodiment of a support member 50 can be seen in FIGS. 18-23. The body 51 can be formed with just the rectangular receptacle 22, as is shown in FIGS. 18-22, or with the double configuration receptacle 32 that is described in greater detail above and is depicted in FIG. 23. The body 51 could also be configured in the same manner as the body 41 shown in FIG. 15. The body 51 is mounted or integrally formed with a stand 55 that is operable to support the body 51 on a flat surface such as a tray or a desk surface.

Accordingly, the stand 55 has a flat bottom surface 56 and is contoured to fit the hand of a dental hygienist, including having a thin, elongated neck portion 57 beneath the body 51 that would enable the dental hygienist to place the stand 55 between fingers, or between the thumb and forefinger, to hold the support member 50 with the body portion 51 positioned above the hand and provide an easy access to the prophy paste in the container supported in the receptacle 22, 32. One skilled in the art will note that the body 51 is preferably not aligned along either the length dimension or the width dimension to the neck portion 57 so that the body 51 is presented for easy access by the dental professional when the neck portion 57 of the stand 55 is held in the hand of the dental professional.

In operation, the prophy paste container 10 preferably will be provided to dental offices in a pre-packaged form with each prophy paste having different flavors that will be appropriately identified and packaged in separate prophy paste containers 10. Once the patient has selected a desired flavor, the dental hygienist will select the corresponding prophy paste container 10 and open the top cover member/seal member 18, separating the seal member 18 from the rim 15 surrounding the upper perimeter of the prophy paste container 10. In the preferable embodiment, the tab 16 would be broken away from the flat rim 15 at the perforation line 16a and removed with the top cover member/seal member 18. The prophy paste container 10 will then likely require placement into a stable support member, 20, 30, 40 or 50.

One such stable support member could be the support member 50, depicted in FIGS. 18-23 and described in greater detail above, which can then be placed on the dental tray with the receptacle formed to receive the rectangular, as appropriate the conventional round, prophy paste container 10 snuggly. Because of the long and narrow configuration of the prophy paste container 10, the prophy paste container 10 is less stable on a flat surface without being placed into a stable support member than the conventional round prior art prophy paste container. Once the container 10 has been emptied or the prophy procedure completed, the container 10 can be lifted out of the support member 20, 30, 40 or 50 and properly disposed, while the support member is available for subsequent use to hold another prophy paste container 10.

One skilled in the art will recognize that the support members, 20, 30, 40 or 50 are preferably formed with a plastic material that can be sterilized repeated after each respective use thereof and returned to multiple re-usage with subsequent patients to restrain a different prophy past container 10 during the cleaning operation.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A prophy paste container for holding dental material for application to a patient by a dental professional with a rotary device having a prophy cup with a diameter dimension, comprising:
a vessel having width, depth and length dimensions defining an upper perimeter, said length dimension being at least twice the value of said width dimension, said width dimension being larger than said diameter dimension of said prophy cup, said vessel having side walls, end walls and a bottom surface;
a flange projecting outwardly from said upper perimeter of said vessel to facilitate handling of said vessel; and
a detachable cover member secured to said flange to maintain sterility of said dental material within said vessel until said cover member is removed from said vessel to permit access to said dental material.

2. The prophy paste container of claim 1 wherein said width dimension of said bottom surface is slightly larger than said diameter dimension of said prophy cup.

3. The prophy paste container of claim 1 wherein said end walls are formed with detent members that project outwardly from the end walls.

4. The prophy paste container of claim 3 wherein said end walls are sloped from said bottom surface upwardly to said flange such that said bottom surface is dimensionally smaller than a length dimension of said flange.

5. The prophy paste container of claim 4 wherein said side walls are perpendicular to said bottom surface and said flange.

6. The prophy paste container of claim 1 wherein said flange extends around said upper perimeter of said vessel and is engaged by said detachable cover member to seal a receptacle of said vessel.

7. The prophy paste container of claim 6 wherein said flange includes a tab member that extends outwardly from said flange.

8. A support member for a prophy paste container to receive and position said prophy paste container at a location convenient to a dental hygienist utilizing the prophy paste container in a prophy operation, comprising:
an elongated body having an upper portion and a lower portion;
a receptacle formed in said upper portion of said body to receive said prophy paste container therein; and
a receiver connected to said lower portion of said body to engage a remote surface to support said prophy paste container at a desired location for access by the dental hygienist.

9. The support member of claim 8 wherein said receptacle is configured to receive an elongated prophy paste container.

10. The support member of claim 9 wherein said receptacle is configured to receive a round prophy paste container in a central portion of said body with said receptacle further including landings on opposing sides of said central portion to receive said elongated prophy paste container spanning across said central portion from one landing to the opposing landing.

11. The support member of claim 9 wherein said prophy paste container is formed with end walls having outwardly projecting detent members, said receptacle being formed with indents that correspond to said detent members and are operable to receive said detent members to retain said prophy paste member within said receptacle during use of the container.

12. The support member of claim 8 wherein said receiver is configured to receive a portion of a dental instrument therein so that said support member can be mounted on said dental instrument.

13. The support member of claim 12 wherein said receiver is formed in a semi-circular configuration to mounted on a shaft member of said dental instrument.

14. The support member of claim 8 wherein said receiver is a stand having a flat bottom for support thereof on a flat exterior surface.

15. The support member of claim 14 wherein said stand is formed with an elongated neck portion underneath said receptacle to permit grasping thereof between fingers of said dental hygienist.

16. A combination elongated prophy paste container and support member therefor for use to engage prophy paste in said prophy paste container by a prophy cup operated by a dental professional during a prophy operation, comprising:
said elongated prophy paste container formed as a vessel having width, depth and length dimensions defining an upper perimeter, said length dimension being larger than said width dimension, said width dimension being larger than said diameter dimension of said prophy cup, said vessel having side walls, end walls and a bottom surface, said prophy paste container including a flange projecting outwardly from said upper perimeter of said vessel to facilitate handling of said vessel, and a detachable cover member secured to said flange to maintain sterility of said dental material within said vessel until said cover member is removed from said vessel to permit access to said dental material; and
said support member formed as an elongated body having an upper portion and a lower portion, a receptacle formed in said upper portion of said body to receive said elongated prophy paste container therein, and a receiver connected to said lower portion of said body to engage a remote surface to support said elongated prophy paste container at a desired location for access by the dental professional.

17. The combination of claim 16 wherein said length dimension is at least twice the width dimension, said end walls being sloped from said bottom surface upwardly to said flange such that said bottom surface is dimensionally smaller than a length dimension of said flange.

18. The combination of claim 16 wherein said end walls are formed with detent members that project outwardly from the end walls, said support member being formed with indents that are positioned to be engaged by said detent members to retain said elongated prophy paste container within said support member.

19. The combination of claim 16 wherein said receptacle is configured to receive a round prophy paste container in a central portion of said body with said receptacle further including landings on opposing sides of said central portion to receive said elongated prophy paste container spanning across said central portion from one landing to the opposing landing.

20. The combination of claim 16 wherein said receiver is formed in a semi-circular configuration to receive a portion of a dental instrument therein so that said support member can be mounted on said dental instrument.

21. The combination of claim 16 wherein said receiver is a stand having a flat bottom for support thereof on a flat exterior surface, said stand being formed with an elongated neck portion underneath said receptacle to permit grasping thereof between fingers of said dental professional.
